(19) United States
(12) Patent Application Publication
(10) Pub. No.: US 2006/0090773 A1
(43) Pub. Date: May 4, 2006

(54) Sulfur hexafluoride remote plasma source clean

(75) Inventors: Soo Young Choi, Fremont, CA (US); Qunhua Wang, San Jose, CA (US)

Correspondence Address: PATTERSON & SHERIDAN, LLP, 3040 POST OAK BOULEVARD, SUITE 1500, HOUSTON, TX, 77056, US

(73) Assignee: Applied Materials, Inc.

(21) Appl. No.: 11/088,327

(22) Filed: Mar. 22, 2005

Related U.S. Application Data
(60) Provisional application No. 60/625,622, filed on Nov. 4, 2004.

(51) Int. Cl. B08B 6/00; B08B 9/00

(52) U.S. Cl. 134/1.1; 134/22.1

(57) ABSTRACT

A method for cleaning a substrate processing chamber including introducing a gas mixture to a remote plasma source, wherein the gas mixture comprises sulfur hexafluoride and an oxygen containing compound selected from the group consisting of oxygen and nitrous oxide, disassociating a portion of the gas mixture into ions, transporting the atoms into a processing region of the chamber, providing an in situ plasma, and cleaning a deposit from within the chamber by reaction with the ions.

### CROSS-REFERENCE TO RELATED APPLICATIONS

This application claims benefit of U.S. provisional patent application Ser. No. 60/625,622, filed Nov. 4, 2004, which is herein incorporated by reference.

### BACKGROUND OF THE INVENTION

1. Field of the Invention

Embodiments of the present invention generally relate to substrate processing chamber and cleaning methods, such as flat panel display, wafer, and solar panel processing chamber and cleaning methods.

2. Description of the Related Art

Substrate processing chambers provide a wide variety of functions. Often, when depositing dielectric layers on the substrate, the residue from the deposition process collects on the walls and other surfaces of the manufacturing chambers. These deposits may become-friable-and contaminate the surface of the substrate. Because the chambers are usually part of an integrated tool to rapidly process substrates, it is essential that maintenance and cleaning of the chambers require minimal time. To reduce the likelihood of contamination and thus improve the throughput of the chambers, effective and timely cleaning the surfaces of the chambers is desirable.

Currently, the mechanisms for removing the silicon or carbon containing deposits from the surfaces of the chamber include in situ RF plasma clean, remote plasma, or RF-assisted remote plasma clean. The in situ RF plasma clean method introduces a fluorine containing precursor to the deposition chamber and dissociates the precursor with RF plasma. The atomic fluorine neutrally charged particles clean by chemically etching the deposits. The in situ plasma generates an energetic mixture of charged and neutral species that accelerate the clean. Unfortunately, the plasma may attack clean surfaces, damaging the surfaces of the chamber and degrading the equipment performance by increasing the likelihood of defects from chamber contamination during the manufacturing process. The damage to the chamber surface that occurs during plasma cleaning may be substantial from both uneven removal of the deposits and from distortion that occurs when the chamber surfaces are exposed to non-uniform plasma. High power plasma can be difficult to apply uniformly throughout the chamber. Lower power plasma requires more process gas for cleaning, increasing the cost of operation and the likelihood of environmental damage.

Historically, nitrogen trifluoride (NF₃) has been used as the fluorine containing precursor. It is a desirable chamber cleaning precursor gas because the mechanical components and other process parameters may be selected to achieve low emission with remote plasma source technology and conventional abatement systems. Molecular fluorine is also a desirable chamber cleaning precursor gas because of the reduced environmental impact and potentially lower operation costs. A reliable and safe molecular fluorine supply for large quantities of gas is not yet available.

Remote plasma with fluorine containing gas may be used for cleaning the chamber surfaces. However, the fluorine containing gas molecules that are dissociated in the remote plasma source may recombine into molecular fluorine that is less reactive with the chamber deposits than dissociated atoms, requiring additional process time or cleaning gas to thoroughly clean the chamber.

Currently, RF-assisted remote plasmas may also be used for cleaning. Combining the high precursor dissociation efficiency of the remote plasma clean with the enhanced cleaning rate of the in situ plasma may effectively clean the chamber surfaces. However, the combined plasma generation sources often form non-uniform plasmas and also result in non-uniform chemical distribution in the chamber. This non-uniform plasma and chemical distribution lead to non-uniform cleaning and surface degradation from overcleaning.

Chemical cleaning agents may also be introduced to the chamber. However, the time required for plasma cleaning the chamber or for exposing the chamber to conventional chemical cleaning agents may be lengthy. The chemicals used for cleaning the chamber may have negative environmental consequences or may be difficult to transport in large quantities. Hence, it is desirable to provide a chamber cleaning method that requires low capital investment, features low raw material cost, and provides reduced damage to the chamber surfaces.

### SUMMARY OF THE INVENTION

The present invention generally provides a method for cleaning a substrate processing chamber including introducing a gas mixture to a remote plasma source, wherein the gas mixture comprises sulfur hexafluoride and an oxygen containing compound selected from the group consisting of oxygen and nitrous oxide, disassociating a portion of the gas mixture into ions, transporting the atoms into a processing region of the chamber, providing an in situ plasma, and cleaning a deposit from within the chamber by reaction with the ions.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic of a chamber configured to have a remote plasma region and a processing region.

FIG. 2 is a chart illustrating the chamber pressure as a function of time for sulfur hexafluoride cleaning performance in one embodiment of the invention.

FIG. 3 is a chart comparing the cleaning time of a film by two cleaning gases as a function of inlet gas flow rate in one embodiment of the invention.

FIG. 4 is a chart comparing the cleaning rate of two hardware conditions as a function of inlet gas flow rate in one embodiment of the invention.

### DETAILED DESCRIPTION

The present invention provides a chamber cleaning method using a mixture of sulfur hexafluoride and oxygen to remove silicon or carbon containing deposits.

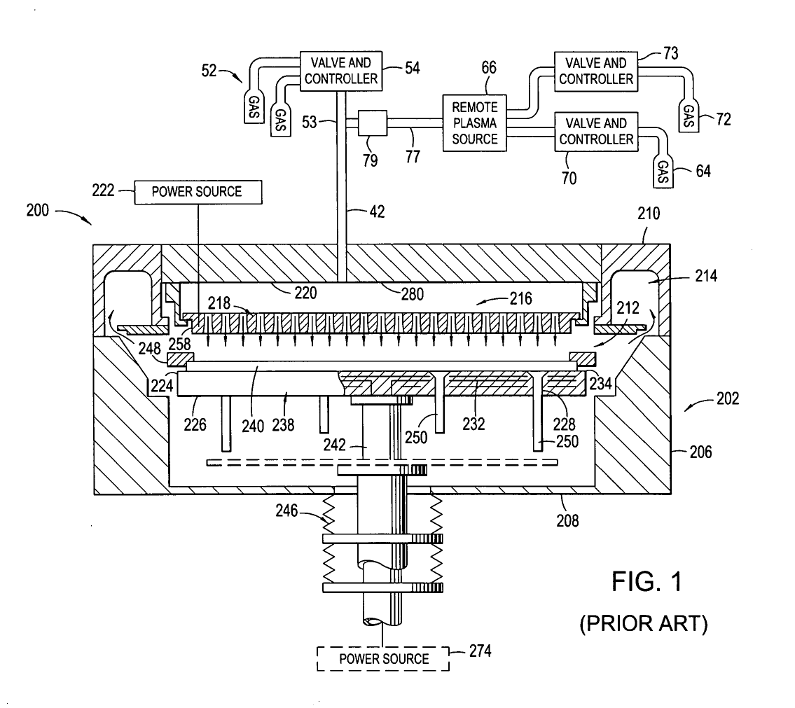

FIG. 1 is a schematic cross-sectional view of one embodiment of a plasma enhanced chemical vapor deposition system 4300, available from AKT, a division of Applied Materials, Inc., of Santa Clara, Calif. Other equipment that may be used for this process includes the 3500, 5500, 10K, 15K, 20K, and 25K chambers, also available from AKT, a division of Applied Materials, Jnc. of Santa Clara, Calif. The system 200 generally includes a processing chamber 202 coupled to a gas source 52. The processing chamber 202 has walls 206 and a bottom 208 that partially define a process volume 212. The process volume 212 is typically accessed through a port (not shown) in the walls 206 that facilitate movement of a substrate 240 into and out of the processing chamber 202. The walls 206 and bottom 208 are typically fabricated from aluminum, stainless steel, or other materials compatible with processing. The walls 206 support a lid assembly 210 that contains a pumping plenum 214 that couples the process volume 212 to an exhaust system that includes various pumping components (not shown).

A gas inlet conduit or pipe 42 extends into the entry port 280 and is connected through a gas switching network 53 to sources of various gases. A gas supply 52 contains the gases that are used during deposition. The particular gases that are used depend upon the materials that are to be deposited onto the substrate. The process gases flow through the inlet pipe 42 into the entry port 280 and then into the chamber 212. An electronically operated valve and flow control mechanism 54 controls the flow of gases from the gas supply into the entry port 280.

A second gas supply system also is connected to the chamber through the inlet pipe 42. The second gas supply system supplies gas that is used to clean the inside of the chamber after a sequence of deposition runs. As used herein, the phrase “cleaning” refers to removing deposited material from the interior surfaces of the chamber. In some situations, the first and second gas supplies can be combined.

The second gas supply system includes a source of a precursor gas 64 such as sulfur hexafluoride, a remote plasma source 66 which is located outside and at a distance from the deposition chamber, an electronically operated valve and flow control mechanism 70, and a conduit or pipe 77 connecting the remote plasma source to the deposition chamber 202. Such a configuration allows interior surfaces of the chamber to be cleaned using a remote plasma source.

The second gas supply system also includes one or more sources of one or more additional gases 72 such as oxygen or a-carrier gas. The additional gases are connected to the remote plasma source 66 through another valve and flow control mechanism 73. The carrier gas aids in the transport of the activated species to the deposition chamber and can be any nonreactive gas that is compatible with the particular cleaning process with which it is being used. For example, the carrier gas may be argon, nitrogen, or helium. The carrier gas also may assist in the cleaning process or help initiate and/or stabilize the plasma in the deposition chamber.

Optionally, a flow restrictor 79 is provided in the pipe 77. The flow restrictor 79 can be placed anywhere in the path between the remote plasma source 66 and the deposition chamber 202. The flow restrictor 79 allows a pressure differential to be provided between the remote plasma source 66 and the deposition chamber 202. The flow restrictor 79 may also act as a mixer for the gas and plasma mixture as it exits the remote plasma source 66 and enters the deposition chamber 202.

The valve and flow control mechanism 70 delivers gas from the precursor gas source 64 into the remote plasma source 66 at a user-selected flow rate. The remote plasma source 66 may be an RF plasma source. The remote plasma source 66 activates the precursor gas to form a reactive species which is then flowed through the conduit 77 into the deposition chamber via the inlet pipe 42. The entry port 280 is, therefore, used to deliver the reactive gas into the interior region of the deposition chamber. In the described implementation, the remote plasma source 66 is an inductively coupled remote plasma source.

The lid assembly 210 provides an upper boundary to the process volume 212. The lid assembly 210 typically can be removed or opened to service the processing chamber 202. In one embodiment, the lid assembly 210 is fabricated from aluminum (Al). The lid assembly 210 includes a pumping plenum 214 formed therein coupled to an external pumping system (not shown). The pumping plenum 214 is utilized to channel gases and processing by-products uniformly from the process volume 212 and out of the processing chamber 202.

The gas distribution plate assembly 218 is coupled to an interior side 220 of the lid assembly 210. The gas distribution plate assembly 218 includes a perforated area 216 through which process and other gases are delivered to the process volume 212. The perforated area 216 of the gas distribution plate assembly 218 is configured to provide uniform distribution of gases passing through the gas distribution plate assembly 218 into the process volume 212. Gas distribution plates that may be adapted to benefit from the invention are described in commonly assigned U.S. patent application Ser. No. 09/922,219, filed Aug. 8, 2001 by Keller, et al.; Ser. No. 10/140,324, filed May 6, 2002; and Ser. No. 10/337,483, filed Jan. 7, 2003 by Blonigan, et al.; U.S. Pat. No. 6,477,980, issued Nov. 12, 2002 to White, et al.; and U.S. patent application Ser. No. 10/417,592, filed Apr. 16, 2003 by Choi, et al., which are hereby incorporated by reference in their entireties.

The diffuser plate 258 is typically fabricated from stainless steel, aluminum (Al), anodized aluminum, nickel (Ni) or other RF conductive material. The diffuser plate 258 is configured with a thickness that maintains sufficient flatness to not adversely affect substrate processing. In one embodiment the diffuser plate 258 has a thickness between about 1.0 inch to about 2.0 inches.

A temperature controlled substrate support assembly 238 is centrally disposed within the processing chamber 202. The support assembly 238 supports a substrate 240 during processing. In one embodiment, the substrate support assembly 238 comprises an aluminum body 224 that encapsulates at least one embedded heater 232. The heater 232, such as a resistive element, disposed in the support assembly 238, is coupled to an optional power source 274 and controllably heats the support assembly 238 and the substrate 240 positioned thereon to a predetermined temperature.

Generally, the support assembly 238 has a lower side 226 and an upper side 234. The upper side 234 supports the substrate 240. The lower side 226 has a stem 242 coupled thereto. The stem 242 couples the support assembly 238 to a lift system (not shown) that moves the support assembly 238 between an elevated processing position (as shown) and a lowered position that facilitates substrate transfer to and from the processing chamber 202. The stem 242 additionally provides a conduit for electrical and thermocouple leads between the support assembly 238 and other components of the system 200.

A bellows 246 is coupled between support assembly 238 (or the stem 242) and the bottom 208 of the processing chamber 202. The bellows 246 provides a vacuum seal between the chamber volume 212 and the atmosphere outside the processing chamber 202 while facilitating vertical movement of the support assembly 238.

The support assembly 238 generally is grounded such that RF power supplied by a power source 222 to a gas distribution plate assembly 218 positioned between the lid assembly 210 and substrate support assembly 238 (or other electrode positioned within or near the lid assembly of the chamber) may excite gases present in the process volume 212 between the support assembly 238 and the distribution plate assembly 218. The support assembly 238 additionally supports a circumscribing shadow frame 248. Generally, the shadow frame 248 prevents deposition at the edge of the glass substrate 240 and support assembly 238 so that the substrate does not stick to the support assembly 238. The support assembly 238 has a plurality of holes 228 disposed therethrough that accept a plurality of lift pins 250.

In operation, fluorine atoms are generated in the remote plasma region of the processing chamber where sulfur hexafluoride containing gas is exposed to remote plasma. The remote plasma disassociates the fluorine and the other atoms in the gas molecule into ionized atoms. The disassociated fluorine atoms flow into the processing region of the processing chamber. Then, an in situ plasma may be applied to the ionized fluorine to provide more uniform dissociation of the fluorine atoms and oxygen atoms. The fluorine atoms and oxygen atoms clean silicon or carbon based deposits or other deposits from the surface of the chamber. Fluorine ions that have recombined as molecular fluorine are not as effective for cleaning silicon nitride or amorphous carbon films as fluorine ions.

The use of fluorine atoms and oxygen atoms as a cleaning gas provides a uniform, predictable plasma for cleaning the chamber. This relatively uniform, predictable plasma evenly cleans the chamber and is less likely to deform or degrade the surfaces of the chamber by overcleaning than some other processes. The time for cleaning the process chambers may be reduced because the uniform cleaning may also be more efficient. Time for cleaning may also be reduced because multiple cycles for remote and in situ plasmas will be reduced.

Sulfur hexafluoride may be used in combination with one or more other fluorine containing gases for cleaning deposits from chamber surfaces. The other fluorine containing gases include molecular fluorine, nitrogen trifluoride, hydrogen fluoride, carbon tetrafluoride, perfluoroethane, and others. Sulfur hexafluoride requires more power to dissociate than other fluorine containing gases. Also, sulfur hexafluoride gases must be dissociated to have the ability to clean. The likelihood of dissociation increases with the presence of additional gases. The additional gases that may be added to the system during cleaning include argon, oxygen containing compounds including oxygen and nitrous oxide, or combinations thereof. Testing indicates that nitrous oxide is not as effective as oxygen.

The 20K™ chamber, available from AKT, a division of Applied Materials, Inc. of Santa Clara, Calif., was used to test the effectiveness of sulfur hexafluoride. RGA testing of exhaust gases indicates that nitrogen, oxygen, SF₅⁺, SF₃⁺, F, SiF₃⁺, SO₂, and F₂ were present in the exhaust gases after sulfur hexafluoride was introduced to a remote plasma chamber and then providing a chamber having an in situ plasma. This gas mixture indicates dissociation of gas molecules and improved cleaning efficiency. An inlet gas flow rate ratio of sulfur hexafluoride to oxygen of about 0.1 to about 10.0 to is desirable to provide the optimum ratio of cleaning components. Deposits that may be cleaned from the chamber surfaces include silicon oxide, carbon doped silicon oxide, silicon carbide, silicon nitride, or amorphous carbon. Power to the remote plasma source may be adjusted from about 0.0 to about 14.6 kW. The power to the remote plasma source may preferably be above 13 kW. RF plasma may be adjusted from 0 to 3 kW, preferably 2.5 kW. Pressure may be adjusted from 100 mTorr to 1 Torr. To prevent chamber damage, in situ RF power may not be desirable when using a sulfur hexafluoride to oxygen volumetric ratio less than 1 to 1. For sulfur hexafluoride to oxygen ratios of 1 to 1 or greater, use of in situ RF power of 1.5 kW or greater, for example 2.5 kW, counteracts recombination of fluorine atoms.

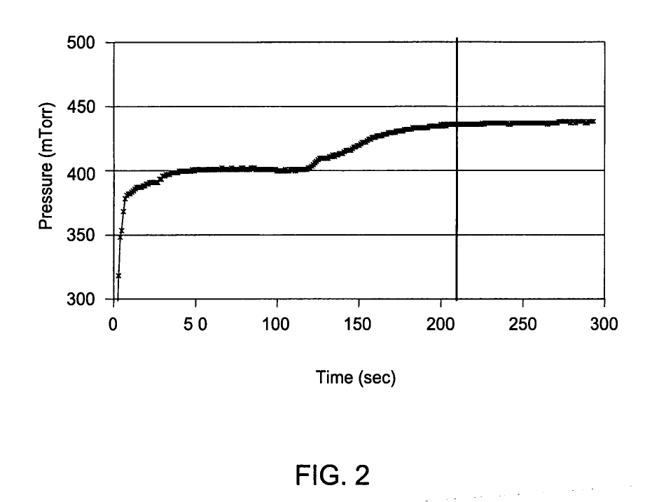

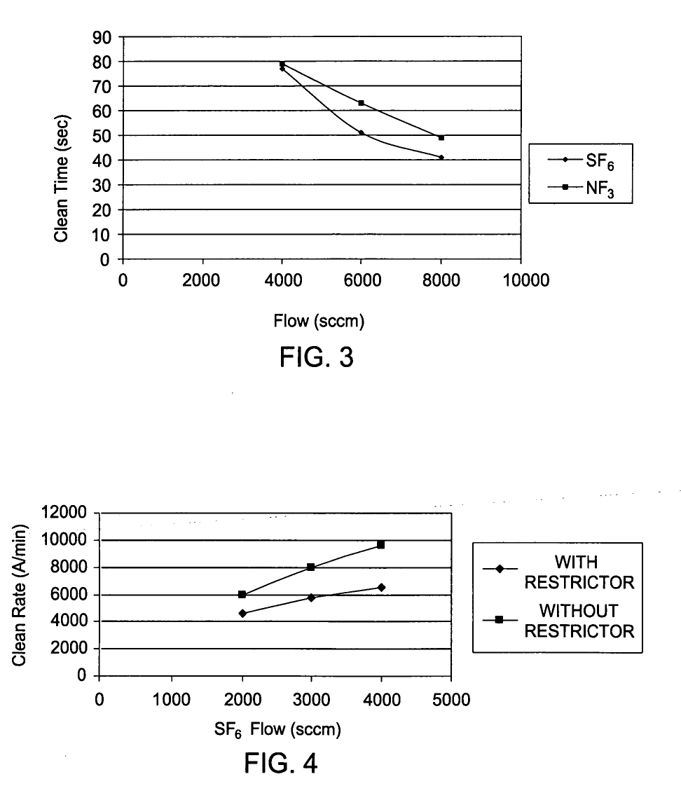

The experimental results depicted in FIGS. 2 and 3 were collected from a plasma enhanced chemical vapor deposition system 20K chamber, available from AKT, a division of Applied Materials, Inc., of Santa Clara, Calif. The remote plasma source is an ASTRON hf+, available from MKS of Wilmington, Mass. FIG. 2 is a chart illustrating the chamber pressure as a function of time for 8 standard liters per minute of sulfur hexafluoride and 8 standard liters per minute of oxygen with 2 kW RF in situ plasma with a substrate support temperature of 275° C. The end point (a dark vertical line in FIG. 2) as indicated by an optical endpoint detector was achieved at 210 seconds. The film thickness was 21000 Å. Thus, the clean rate was 6000 Å/min. This clean rate is comparable to NF₃ at similar flow rates with no RF in situ plasma.

For the experimental results illustrated by FIG. 3, the chambers are configured to process a substrate with a surface area of 20K chamber, 1950 cm². FIG. 3 is a chart comparing the cleaning time of a film by nitrogen trifluoride and sulfur hexafluoride as a function of inlet gas flow rate. The substrate support temperature was 275° C. The sulfur hexafluoride was added to the chamber with oxygen in a one to one ratio. The cleaning time for the sulfur hexafluoride was 20 percent higher than for the nitrogen hexafluoride when the same remote plasma conditions were used. The cleaning time for sulfur hexafluoride was lower than for nitrogen trifluoride when 1.4 kW RF in situ plasma was also used for the sulfur hexafluoride tests.

Mixtures of sulfur hexafluoride, oxygen, and argon were also tested over similar flow rates as those depicted in FIG. 3. The observed clean time was 50 seconds at 8000 sccm sulfur hexafluoride, 8000 sccm oxygen, and 1000 sccm argon compared to 49 seconds for comparable sulfur hexafluoride and oxygen flow rates and 41 seconds for comparable nitrogen trifluoride flow rates.

As the flow rates of the inlet gases were increased above 8000 sccm, the efficiency of the remote plasma source decreased. That is, as the power increased proportionally to the increase in inlet gas flow rates, the cleaning rate of the system did not increase proportionally, and, in some cases, decreased.

Another experiment described in FIG. 4 was carried out using AKT 4300 chamber. FIG. 4 is a chart comparing the cleaning rate of two hardware conditions as a function of inlet gas flow rate. The silicon nitride film that was removed from the chamber surfaces was deposited in a chamber with 1100 mils between the gas distribution plate and the upper substrate surface at 420° C. and 1.5 Torr with 400 sccm silane, 1400 sccm ammonia, and 4000 sccm nitrogen with RF power of 1200W. For one set of data, the system was configured to include a flow restrictor. For the second set of data, the system had the flow restrictor removed. The cleaning time results indicate that the system without the flow restrictor has approximately 20 to 50 percent faster clean rates over each of the flow rates tested. Thus, the additional mixing provided by the flow restrictor does not improve the cleaning process.

Burn in testing was performed on the 20K™ chamber available from AKT, a division of Applied Materials of Santa Clara, Calif. The testing indicated that the cleaning effectiveness of the sulfur hexafluoride was comparable to the nitrogen trifluoride. Also, SIMS measurements of films deposited in chambers cleaned by sulfur hexafluoride or nitrogen trifluoride were performed. The films had no significant difference in film chemical properties.

A larger chamber was also used for testing, the 25KAX™ chamber available from AKT, a division of Applied Materials of Santa Clara, Calif. As the chamber and substrate sizes grow larger, the clean rate of sulfur hexafluoride based systems is slightly lower than nitrogen trifluoride based systems. The pressure drop across the system, which is a rough estimate of dissociation efficiency, is not proportionate to the change in chamber size when using sulfur hexafluoride. More power needs to be applied to the remote and in situ plasma generators for sulfur hexafluoride. Removal of the flow restrictor after the remote plasma generator did not change the effectiveness of the system

Generally, there was no difference in chamber integrity observed during any of the nitrogen trifluoride or sulfur hexafluoride trials. The end point detection system worked effectively for both nitrogen trifluoride and sulfur hexafluoride inlet gas mixtures. The mathematical models used to predict cleaning effectiveness of nitrogen trifluoride accurately predict the cleaning effectiveness of sulfur hexafluoride and oxygen. These results may be combined with economic data to indicate that the cost ratio of nitrogen trifluoride to sulfur hexafluoride is approximately 4.2. Therefore, the cleaning gas cost reduction by using sulfur hexafluoride instead of nitrogen trifluoride is approximately 72 percent.

While the foregoing is directed to embodiments of the present invention, other and further embodiments of the invention may be devised without departing from the basic scope thereof, and the scope thereof is determined by the claims that follow.

1. A method for cleaning a substrate processing chamber comprising:
introducing a gas mixture to a remote plasma source, wherein the gas mixture comprises sulfur hexafluoride and an oxygen containing compound and wherein the power to the remote plasma source is above about 13 kW;
disassociating a portion of the gas mixture into ions while applying power to the remote plasma source;
transporting the gas mixture into a processing region of the chamber; and
cleaning a deposit from within the chamber by reaction with the ions while providing an in situ plasma.

2. The method of claim 1, wherein the gas mixture further comprises a carrier gas.

3. The method of claim 2, wherein the carrier gas is argon.

4. The method of claim 1, wherein the in situ plasma is formed by applying Rf power.

5. The method of claim 1, wherein a ratio of the oxygen containing compound to the sulfur hexafluoride in the gas mixture is about 0.1 to about 10.0.

6. The method of claim 1, wherein the ratio of the oxygen containing compound to the sulfur hexafluoride is approximately 1 to 1.

7. The method of claim 1, wherein a pressure of the chamber is about 0.1 to about 1 Torr.

8. (canceled)

9. The method of claim 1, wherein the oxygen containing compound is selected from the group consisting of oxygen and nitrous oxide.

10. A method for cleaning a substrate processing chamber comprising:
introducing a gas mixture to a remote plasma source, wherein the gas mixture comprises sulfur hexafluoride and an oxygen containing compound and wherein the power to the remote plasma source is above about 13 kW;
disassociating a portion of the gas mixture into ions while applying power to the remote plasma source;
transporting the gas mixture into a processing region of the chamber;
cleaning a deposit from within the chamber by reaction with the ions while providing an in situ plasma; and
exhausting a combination of the gas mixture and deposit from the chamber.

11. The method of claim 10, further comprising sending a signal from an end point detector to a controller.

12. The method of claim 10, wherein the gas mixture further comprises a carrier gas.

13. The method of claim 12, wherein the carrier gas is argon.

14. The method of claim 10, wherein the in situ plasma is formed by applying Rf power.

15. The method of claim 10, wherein a ratio of the oxygen containing compound to the sulfur hexafluoride in the gas mixture is about 0.1 to about 10.0.

16. The method of claim 15, wherein the ratio of the oxygen containing compound to the sulfur hexafluoride is approximately 1 to 1.

17. The method of claim 10, wherein a pressure of the chamber is about 0.1 to about 1 Torr.

18. (canceled)

19. The method of claim 10, wherein the oxygen containing compound is selected from the group consisting of oxygen and nitrous oxide.

20. A method for cleaning a substrate processing chamber comprising:
introducing a gas mixture to a remote plasma source, wherein the gas mixture comprises sulfur hexafluoride and an oxygen containing compound selected from the group consisting of oxygen and nitrous oxide and wherein the power to the remote plasma source is above about 13 kW;
disassociating a portion of the gas mixture into ions while applying power to the remote plasma source;
transporting the gas mixture into a processing region of the chamber;
cleaning a deposit from within the chamber by reaction with the ions while providing an in situ plasma; and
sending a signal from an end point detector to a controller.
